(19) United States
(12) Patent Application Publication
(10) Pub. No.: US 2007/0076748 A1
(43) Pub. Date: Apr. 5, 2007

(54) Communication apparatus and communication control method

(76) Inventor: Hideyuki Nakagawa, Kodaira-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/529,682

(22) Filed: Sep. 27, 2006

(30) Foreign Application Priority Data
Sep. 30, 2005 (JP) 2005-288380

(51) Int. Cl. H04L 12/66; H04J 3/16

(52) U.S. Cl. 370/463; 370/466

(57) ABSTRACT

According to one embodiment, there is provided a communication apparatus performing wireless communication with an external device. The communication apparatus includes a detection unit configured to detect one or more emulation protocols supported by the external device, a selection unit configured to select, from the one or more emulation protocols detected by the detection unit, an emulation protocol which is supported by the communication apparatus, and a connection unit configured to establish a wireless connection with the external device in accordance with the emulation protocol selected by the selection unit.

### CROSS-REFERENCE TO RELATED APPLICATIONS

This application is based upon and claims the benefit of priority from Japanese Patent Application No. 2005-288380, filed Sep. 30, 2005, the entire contents of which are incorporated herein by reference.

### BACKGROUND

1. Field

One embodiment of the invention relates to a communication apparatus such as a personal computer which performs wireless communication, and more particularly, to a communication apparatus supporting a plurality of kinds of communication methods and a communication control method for use in the communication apparatus.

2. Description of the Related Art

In recent years, personal computers have been developed which correspond to each of many kinds of communication methods. Such computers include communication interfaces for performing communication corresponding to each of the many kinds of communication methods.

For example, Japanese Patent Application (KOKAI) No. 2004-187184 discloses a technique which switches wireless communication methods to be used. Merely by selecting a wireless communication method to be used by operating a user terminal, a user can easily and quickly switch to a selected wireless communication.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram for explaining an exemplary network system configuration of wireless communication performed between an external device and a communication apparatus according to an embodiment of the invention;

FIG. 2 is an exemplary block diagram showing an exemplary system configuration of the communication apparatus of FIG. 1;

FIG. 3 is an exemplary block diagram showing an exemplary structure/functions of a virtual bus selection unit provided in the communication apparatus of FIG. 1;

FIG. 4 is an exemplary block diagram for explaining exemplary hierarchical structures of protocol stacks of the external device and the communication apparatus of FIG. 1;

FIG. 5 is an exemplary timing chart showing an exemplary emulation protocol selection process which is performed by a virtual bus selection unit of the communication apparatus of FIG. 1; and

FIG. 6 is an exemplary flowchart for explaining an exemplary procedure for establishing a wireless connection between and the external device and the communication apparatus of FIG. 1.

### DETAILED DESCRIPTION

Various embodiments according to the invention will be described hereinafter with reference to the accompanying drawings. In general, according to one embodiment of the invention, there is provided a communication apparatus performing wireless communication with an external device, the communication apparatus including: a detection unit configured to detect one or more emulation protocols supported by the external device; a selection unit configured to select, from the one or more emulation protocols detected by the detection unit, an emulation protocol which is supported by the communication apparatus; and a connection unit configured to establish a wireless connection with the external device in accordance with the an emulation protocol selected by the selection unit.

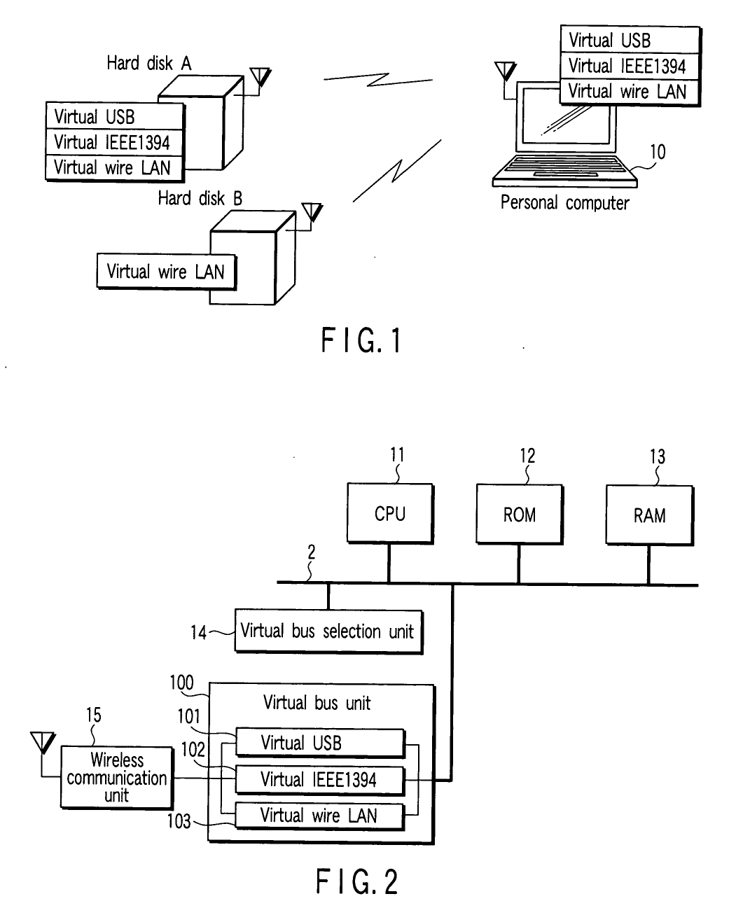

FIG. 1 shows an exemplary network system configuration using a communication apparatus according to one embodiment of the invention. The communication apparatus is realized as, for example, a notebook personal computer 10. The computer 10 includes a virtual bus function which emulates a wire communication function of an existing bus. The virtual bus function is realized by an emulation protocol. The emulation protocol is a protocol which converts a procedure for performing wire communication into a procedure for performing wireless communication. There are various kinds of emulation protocols, such as a virtual USB emulation protocol which emulates wire communication conforming to, e.g., USB (Universal Serial Bus) standard, a virtual IEEE1394 emulation protocol which emulates wire communication conforming to an IEEE (Institute of Electrical and Electronics Engineers) standard, and a virtual wire LAN (Local area network) emulation protocol which emulates wire communication corresponding to, e.g., Ethernet (registered trademark) standard.

The computer 10 supports three kinds of virtual bus functions: a virtual USB function; a virtual IEEE1394 function; and a virtual wire LAN function. The computer 10 selectively uses three kinds of emulation protocols, i.e., a USB emulation protocol, an IEEE1394 emulation protocol, and a virtual wire LAN emulation protocol, thereby establishing a wireless connection between the computer 10 and an external device, which is a connection target.

A hard disk A and a hard disk B are external devices which are wireless connection targets of the computer 10. The hard disk A supports a virtual USB function, a virtual IEEE1394 function, and a virtual wire LAN function. The hard disk B supports only the virtual wire LAN function.

In the case where, for example, wireless communication is performed between the computer 10 and the hard disk A, the computer 10 detects an emulation protocol supported by the hard disk A, and performs an emulation protocol selection process which selects an emulation protocol supported by the hard disk A among a plurality of kinds of emulation protocols supported by the computer 10. The computer 10 establishes a wireless connection between the computer 10 and the hard disk A by using the emulation protocol selected by the emulation protocol selection process.

Wireless communication methods used for wireless connection in this embodiment include, for example, Bluetooth, wireless LAN (local area network), and UWB (Ultra Wide Band) wireless communication, which uses a communication band wider than that of a wideband communication technique. If a high communication speed is desired, it is desirable to apply UWB wireless communication.

Next, referring to FIG. 2, a description is given of an exemplary system configuration of the computer 10. The computer 10 includes, for example, a CPU 11, a ROM (read only memory) 12, a RAM (random access memory) 13, a virtual bus selection unit 14, a virtual bus unit 100, and a wireless communication unit 15, etc.

The CPU 11 controls each component of the computer 10. In addition, the CPU 11 executes, for example, various programs stored in the ROM 12. The ROM 12, the RAM 13, the virtual bus selection unit 14, and the virtual bus unit 100 are coupled to the CPU 11 via a bus 2. The RAM 13 is a memory device for storing, for example, data.

The virtual bus selection unit 14 selects an emulation protocol supported by an external device (the hard disk A or the hard disk B) among emulation protocols supported by the virtual bus unit 100. The virtual bus unit 100 performs an emulation process in accordance with the selected emulation protocol, and establishes a wireless connection between the computer 10 and the external device.

The wireless communication unit 15 is a wireless communication device which performs wireless communication between the computer 10 and the external device (the hard disk A and the hard disk B), which is a connection target, in accordance with the emulation protocol in the virtual bus unit 100 selected by the virtual bus selection unit 14.

The virtual bus unit 100 stores emulation protocols for performing virtual bus functions supported by the computer 10. The virtual bus unit 100 stores emulation protocols corresponding to a virtual USB function 101, a virtual IEEE1394 function 102, and a virtual wire LAN function 103.

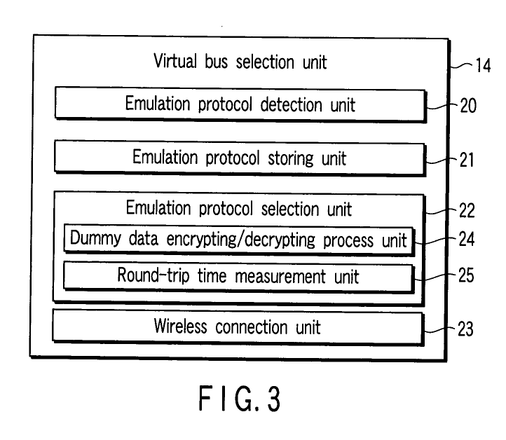

Next, referring to FIG. 3, a description is given of exemplary structure/functions of the virtual bus selection unit 14. The virtual bus selection unit 14 includes an emulation protocol detection unit 20, an emulation protocol storing unit 21, an emulation protocol selection unit 22, and a wireless connection unit 23.

The emulation protocol detection unit 20 detects one or more emulation protocols supported by each of the computer 10 and the external device (the hard disk A or the hard disk B). Specifically, the emulation protocol detection unit 20 detects the kinds and number of emulation protocols supported by the external device (the hard disk A or the hard disk B). Then, the emulation protocol detection unit 20 detects emulation protocols which are supported by the computer 10 as well as the external device, and stores, in the emulation protocol storing unit 21, information indicating the kinds and number of the thus detected emulation protocols.

The emulation protocol selection unit 22 selects one emulation protocol based on the information stored in the emulation protocol storing unit 21 if the emulation protocol detection unit 20 detects a plurality of kinds of emulation protocols. The wireless connection unit 23 establishes a wireless connection between the computer 10 and the external device (the hard disk A or the hard disk B) in accordance with the communication method of the emulation protocol selected by the emulation protocol selection unit 22.

In addition, the emulation protocol selection unit 22 includes a dummy data encrypting/decrypting process unit 24 and a round-trip time measurement unit 25. In the case where a plurality of kinds of emulation protocols are stored in the emulation protocol storing unit 21, the emulation protocol selection unit 22 selects emulation protocol one by one. When an emulation protocol is selected from the plurality of kinds of emulation protocols, the wireless connection unit 23 temporarily establishes a wireless connection between the computer 10 and the external device in accordance with the selected emulation protocol. When the wireless connection is temporarily established, the wireless connection unit 23 performs a transfer process which transfers dummy data between the computer 10 and the external device. The dummy data encrypting/decrypting process unit 24 performs a process which encrypts and decrypts packets of dummy data to be transmitted from the computer 10 to the external device. Specifically, the dummy data encrypting/decrypting process unit 24 may use, for example, a RTT measuring function of DTCP (Digital Transmission Content Protection).

The round-trip time measuring unit 25 measures, for each kind of emulation protocol, a round trip time (RTT) since transmission of dummy data is started until an acknowledgement packet corresponding to the transmitted dummy data is transmitted. The measured round trip time is written in, for example, the RAM 13. The emulation protocol selection unit 22 selects an emulation protocol for which the shortest round trip time is measured among a plurality of round trip times measured by the round trip time measurement unit 25.

In the case where each of the computer 10 and the external device supports a plurality of kinds of emulation protocols, an emulation protocol which can preferably perform wireless communication is automatically selected among the plurality of kinds of emulation protocols supported by the computer 10.

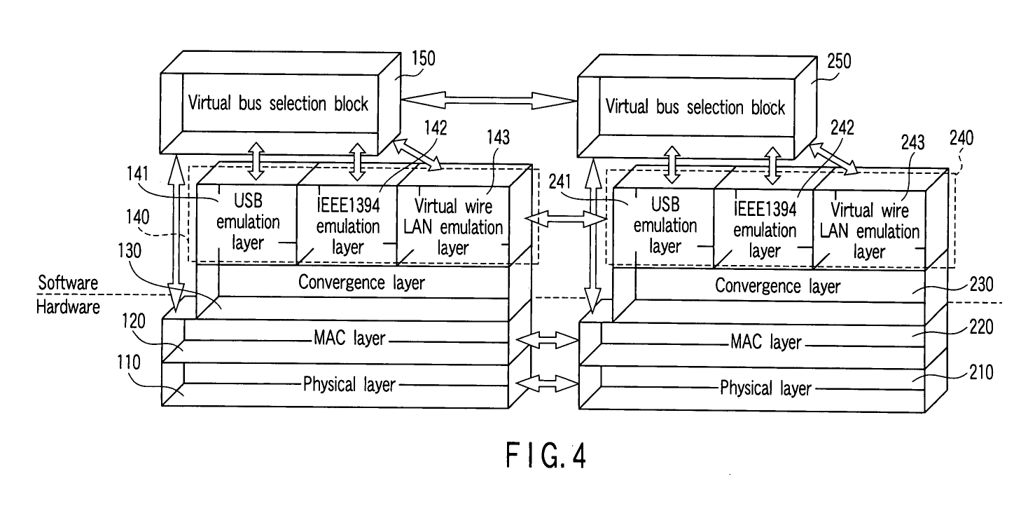

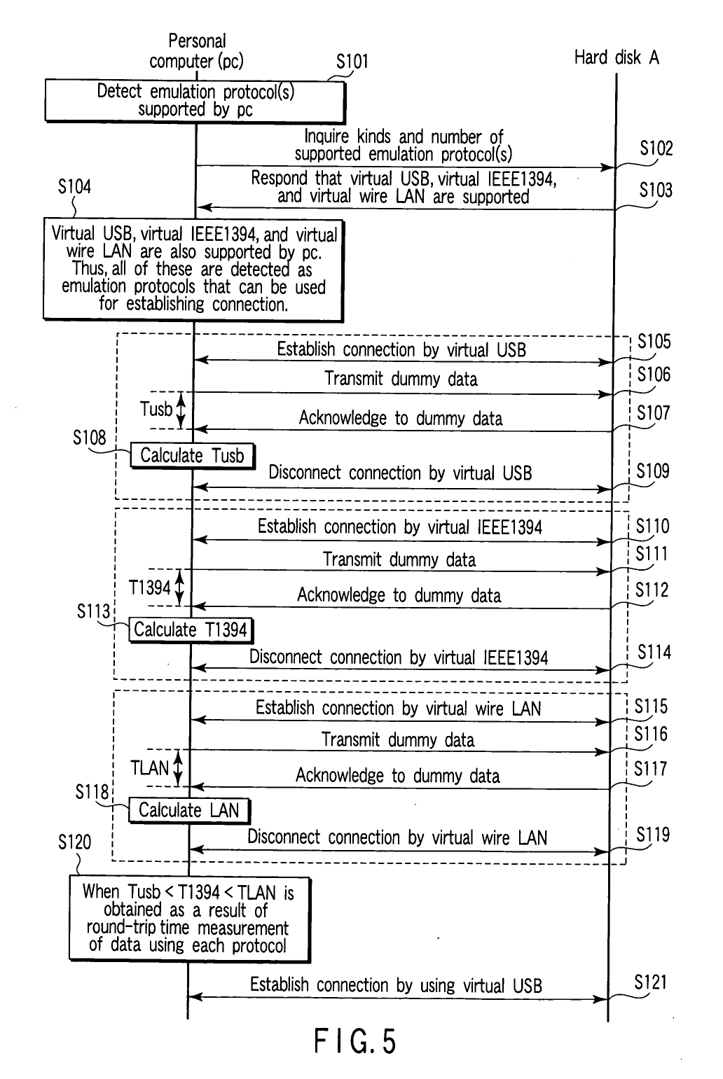

Next, referring to FIG. 4, a description is given of exemplary hierarchical structures of protocol stacks of the computer 10 and the external device. The hierarchical structure of communication protocol of the computer 10 includes a physical layer 110, a MAC (Media Access Control) layer 120, a convergence layer 130, a virtual bus block 140, a virtual bus selection block 150, etc. The virtual bus block 140 includes a USB emulation layer 141, an IEEE1394 emulation layer 142, and a wire LAN emulation layer 143.

The hierarchical structure of the protocol stack of the external device (the hard disk A and the hard disk B) includes a physical layer 210, a MAC layer 220, a convergence layer 230, a virtual bus block 240, and a virtual bus selection block 250. The virtual bus block 240 includes a USB emulation layer 241, an IEEE1394 emulation layer 242, and a wire LAN emulation layer 243. In this exemplary hierarchical structure, the physical layers 110 and 210, and the MAC layers 120 and 220 are formed by hardware, the convergence layers 130 and 230, the virtual bus blocks 140 and 240, and the virtual bus selection blocks 150 and 250 are formed by software.

The physical layers 110 and 210 are layers which define physical transmission methods and connection methods. The MAC layers 120 and 220 are layers which define the structures of data frames to be transmitted and received, methods of accessing media, and methods of connecting to external devices. The convergence layers 130 and 230 are layers which transmit, to lower MAC layers 120 and 220, data transmitted from each of the emulation layers included in the virtual bus blocks 140 and 240, which blocks are higher than the convergence layers 130 and 230, and transmit data transmitted from the MAC layers 120 and 220 to each of the emulation layers, respectively. The virtual bus blocks 140 and 240 include functions which emulate as if the physical layers are coupled via existing wire buses to higher applications or user applications, though the physical layers define a wireless transmission method. The USB emulation layers 141 and 241 include functions which perform communication by emulating a wire communication method conforming to the USB standard on a wire communication method, and correspond to the virtual USB function 101 shown in FIG. 2. The IEEE1394 emulation layers 142 and 242 include functions which perform wireless communication by emulating a wire communication method conforming to IEEE1394 on the wire communication method, and correspond to the IEEE1394 function 102 shown in FIG. 2. The wire LAN emulation layers 143 and 243 include functions which perform wireless communication by emulating a wire communication method conforming to, e.g., Ethernet, as a wireless communication method, and correspond to the virtual wire LAN function 103 shown in FIG. 2. The virtual bus blocks 140 and 240 also include functions which emulate connection in accordance with the RS-232C standard on the wireless communication method. The functions corresponding to the virtual bus blocks 140 and 240 may be seen in existing wireless systems: for example, a BNEP (Bluetooth network encapsulation protocol) or a RFCOMM (Radio Frequency Communication) protocol which emulates connection in accordance with the RS-232 standard in a protocol stack of the Bluetooth standard. In addition, functions corresponding to the virtual bus blocks 140 and 240 include, for example, Wireless USB which performs wireless communication in accordance with the USB standard in a protocol stack of UWB wireless communication, and Wireless 1394 which performs wireless communication in accordance with the IEEE1394 standard.

The virtual bus selection block 150 maintains information of the emulation protocols supported by the computer 10, and search for the emulation protocols supported by the external device. The virtual bus selection block 150 extracts emulation protocols supported by the external device from among the emulation protocols supported by the computer 10. The virtual bus selection block 150 selects one emulation protocol from the extracted emulation protocols, and establishes a wireless connection between the computer 10 and the hard disk A by using the selected emulation protocol. Each of the virtual bus selection blocks 150 and 250 corresponds to the function of the virtual bus selection unit 14 shown in FIG. 2.

Next, referring to FIG. 5, a description is given of an emulation protocol selection process which is performed by the virtual bus selection unit 14. In FIG. 5, an exemplary case is shown where a wireless connection is established between the computer 10 and the hard disk A.

The computer 10 detects emulation protocols supported by the computer 10 (S101). In S101, under control by the CPU 11, the kinds and number of emulation protocols (emulation protocol layers) supported by the computer 10 are detected. The computer 10 transmits, to the hard disk A, a request for detecting the kinds of emulation protocols supported by the hard disk A and the number of the kinds of the emulation protocols supported by the hard disk A (S102). In response to the inquiry request transmitted from the computer 10, the hard disk A detects the kinds of emulation protocols supported by the hard disk A and the number of the emulation protocols. The hard disk A transmits, to the computer 10, an acknowledgement packet indicating that the virtual USB emulation protocol, the virtual IEEE1394 emulation protocol, and the virtual wire LAN emulation protocol are supported (S103). As step S104, the computer 10 detects that virtual USB protocol, virtual IEEE1394 protocol, and virtual wire LAN protocol are supported by the computer 10, and thus the computer 10 determines that communication can be performed by using all kinds of communication protocols, i.e., communication protocols (virtual USB protocol, virtual IEEE1394 protocol, and virtual wire LAN protocol) supported by the computer 10 and the hard disk A. Here, it is assumed that the computer 10 and the hard disk A are detected as devices which can perform wireless communication by using all kinds of emulation protocols, i.e., three kinds of emulation protocols supported by the computer 10 and three kinds of emulation protocols supported by the hard disk A.

Then, a data transfer process using each of the three kinds of detected emulation protocols is performed. More specifically, the computer 10 temporarily establishes a connection between the computer 10 and the hard disk A with selecting the virtual USB protocol (S105). After the connection is established, the computer 10 transmits dummy data, such as “ping”, to the hard disk A (S106). The hard disk A receives the dummy data transmitted from the computer 10, and transmits, to the computer 10, an acknowledgement packet indicating that the dummy data is received (S107). The computer 10 measures a round trip time T_{USB} between the computer 10 and the hard disk A by using the virtual USB protocol, and stores the measured result (S108). The computer 10 disconnects the connection established between the computer 10 and the hard disk A (S109).

Next, the computer 10 temporarily establishes a connection between the computer 10 and the hard disk A with selecting the virtual IEEE1394 protocol. After the connection is established, the computer 10 transmits dummy data, such as “ping”, to the hard disk A (S111). The hard disk A receives the dummy data transmitted from the computer 10, and transmits, to the computer 10, an acknowledgement packet indicating that the dummy data is received (S112). The computer 10 measures a round trip time T₁₃₉₄ between the computer 10 and the hard disk A in wireless communication corresponding to the virtual IEEE1394 protocol, and stores the measured result (S113). The computer 10 disconnects the connection established between the computer 10 and the hard disk A (S114).

Next, the computer 10 temporarily establishes a connection between the computer 10 and the hard disk A with selecting the virtual wire LAN protocol (S115). After the connection is established, the computer 10 transmits dummy data, such as “ping”, to the hard disk A (S116). The hard disk A receives the dummy data transmitted from the computer 10, and transmits, to the computer 10, an acknowledgement packet indicating that the dummy data is received (S117). The computer 10 measures a round trip time T_{LAN} between the computer 10 and the hard disk A in wireless communication corresponding to the virtual wire LAN protocol, and stores the measured result (S118). The computer 10 disconnects the connection established between the computer 10 and the hard disk A (S119). In the case where the measured results of the round trip time of each data using each emulation protocol is, for example, T_{USB}, T₁₃₉₄, and T_{LAN} in the order of short round trip time, the computer 10 selects the virtual USB protocol, and establishes a wireless connection between the computer 10 and the hard disk A by using the selected virtual USB protocol (S120, S121). Thus, the computer 10 selects a communication protocol with the shortest round trip time among the measured results of the round trip time of the dummy data, and establishes a wireless connection between the computer 10 and the external device by using the selected communication protocol. As for the transfer process performed between the computer 10 and the external device, it is assumed to be most efficient to perform wireless communication by using the emulator protocol for which the shortest round trip time is measured. The user can automatically use preferable wireless communication among a plurality of wireless communication functions which can be performed by the computer 10.

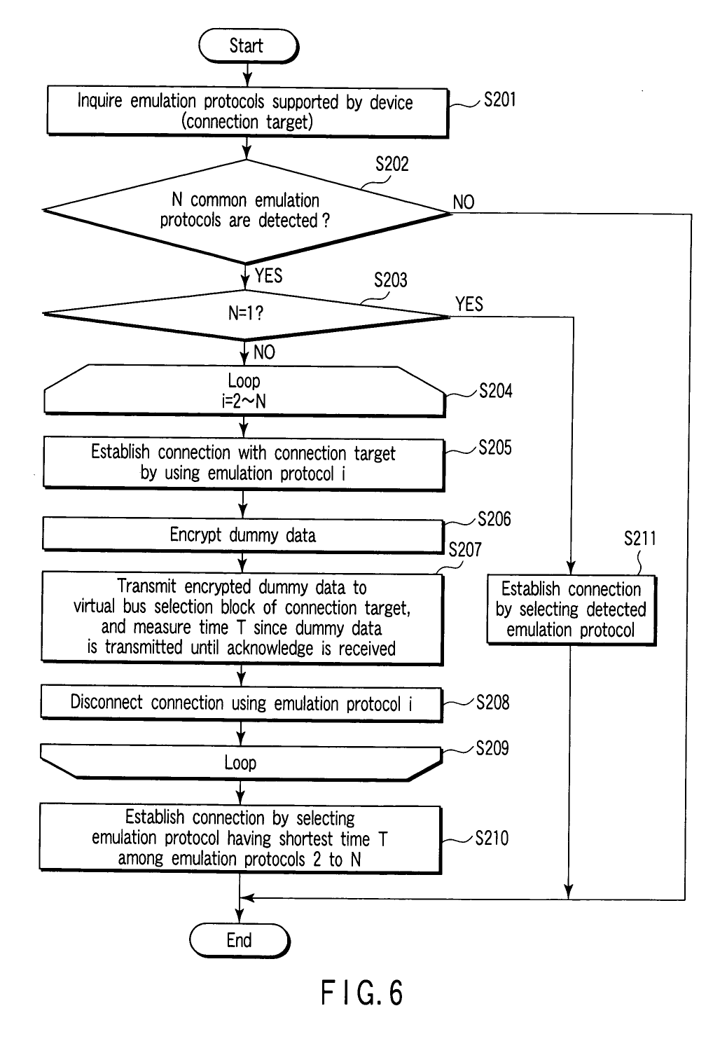

Next, referring to a flowchart of FIG. 6, a description is given of an exemplary procedure for establishing a wireless connection between the computer 10 and the external device.

The virtual bus selection block 150 inquires of the external device, which is the connection target of the computer 10, one or more emulation protocols supported by the external device (S201). In S201, the virtual bus selection block 150 also inquires of the virtual bus block 140 one or more emulation protocols supported by the computer 10. The virtual bus selection block 150 selects one or more emulation protocols supported by the computer 10 from among the one or more emulation protocols included in the response, corresponding to the inquiry, from the hard disk A. The virtual bus selection block 150 recognizes the selected emulation protocol(s) as the emulation protocol(s) by which a wireless connection can be established with the hard disk A. That is, the virtual bus selection block 150 detects one or more emulation protocols which are common between the emulation protocols supported by the computer 10 and the emulation protocols supported by the external device (S202). In the case where two or more common emulation protocols are detected (NO in S203), the virtual bus selection block 150 performs a transfer process for each kind of detected emulation protocol. Stated another way, in the transfer process, as described below, the process from S204 through S208 is repeatedly performed the same number of times as the number of the detected emulation protocols. In this embodiment, the case is assumed where N (N>1) or more emulation protocols are detected (for example, an emulation protocol i, an emulation protocol i+1, . . . ).

A wireless connection is established between the computer 10 and the external device by using one emulation protocol (emulation protocol i) among the detected N different kinds of emulation protocols (emulation protocol i, emulation protocol i+1, . . . ) (S205). The virtual bus selection block 150 encrypts dummy data to be transmitted to the external device (S206). Based on the communication method established between the computer 10 and the external device, the virtual bus selection block 150 transmits the encrypted dummy data to the virtual bus selection block 250 of the external device, and measures the time period since the dummy data is transmitted until an acknowledge packet is received (S207). In S207, the virtual bus selection block 250 decrypts the packet of the dummy data transmitted from the virtual bus selection block 150, and encrypts and transmits, to the virtual bus selection block 150, the acknowledge packet which indicates that the dummy data is received. The virtual bus selection block 150 decrypts the received acknowledge packet. Since the dummy data is encrypted and decrypted, it is possible to prevent, for example, alteration of the dummy data transmitted to the external device from the computer 10 or spoofing of dummy data which pretends to be the dummy data transmitted from the computer 10. In addition, since the dummy data is encrypted/decrypted, it is possible to authenticate, between the computer 10 and the external device, that the computer 10 and the external device are devices which correspond to the wireless communication established between them. Hence, it is possible to properly measure the round trip time of dummy data transferred between the computer 10 and the external device, and a correct measurement result can be obtained.

Based on the communication method of the wireless connection established between the computer 10 and the external device, the virtual bus selection block 150 transmits dummy data to the virtual bus selection block 250 of the external device. The virtual bus selection block 250 authenticates that the computer 10 is a device which corresponds to the established communication method by decrypting the encrypted dummy data, and transmits, to the virtual bus selection block 150, an acknowledgement packet indicating that the computer 10 is authenticated. The virtual bus selection block 150 measures a time period T since the dummy data is transmitted until the acknowledge packet is received (S207). In S207, a time period Ti using the selected emulation protocol i is stored in, for example, the RAM 13. The virtual bus selection block 150 disconnects the connection established by using the emulation protocol i (S208). After the time period Ti is measured, the process of S207 to S208 is performed again, a time period Ti+1 using the emulation protocol i+1, which is other than the emulation protocol i, is measured, and the measured time period Ti+1 is maintained. In this manner, the time period between the computer 10 and the external device is measured for each kind of detected emulation protocol.

Then, the virtual bus selection block 150 selects an emulation protocol for which the shortest time period is measured from all kinds of emulation protocols for which the measurement is performed, and establishes a wireless connection between the computer 10 and the external device by using the selected emulation protocol (S210). In S210, in the case where, for example, the measured result is Ti<Ti+1, the emulation protocol i is selected, and wireless communication is performed by using the selected emulation protocol i.

On the other hand, in the case where the number of kinds of detected emulation protocols is one (YES in S203), the virtual bus selection block 150 selects the detected emulation protocol, and establishes a wireless connection between the computer 10 and the external device by using the selected emulation protocol (S211).

For example, in the case where a wireless connection is established between the computer 10 and the hard disk B, it is detected that only the virtual wire LAN is supported by the hard disk B among the three kinds of emulation protocols supported by the computer 10. Then, the virtual bus selection block 150 establishes a wireless connection between the computer 10 and the hard disk B in accordance with the detected virtual wire LAN protocol. As described above, in the case where the external device supports only one kind of emulation protocol, the transfer process is not performed. The only one kind of emulation protocol which is supported by the hard disk B is automatically selected from a plurality of kinds of emulation protocols supported by the computer 10, and a wireless connection is established between the computer 10 and the external device in accordance with the selected emulation protocol.

As mentioned above, in this embodiment, a plurality of kinds of emulation protocols supported by the computer 10 are automatically selected from a plurality of kinds of emulation protocols supported by the external device. Thus, the user can perform wireless communication between the computer 10 and the external device without operating, for example, a GUI (Graphical User Interface) and an operation switch, etc.

In this embodiment, a round trip time is calculated based on single transmission of dummy data and an acknowledge with respect to the dummy data. However, the virtual bus selection unit 14 (virtual bus selection block 140) may measure the time period from transmission of dummy data to reception of an acknowledge with respect to the dummy data multiple number of times, and may calculate the average value of the measured time periods. That is, the average value of time periods measured by performing the transfer process multiple number of times is calculated for each kind of emulation protocol, and the emulation protocol for which the smallest average value is calculated is selected from the calculated average values.

In addition, in this embodiment, the exemplary case is described where the computer 10 establishes a wireless connection with the hard disk A. However, the emulation protocol selection process may be similarly applied to the case where the hard disk A establishes a wireless connection with the computer 10. The emulation protocol selection process is not dependent on the kinds of devices which attempt to establish a connection.

Further, in the transfer process, it is not necessary to encrypt/decrypt the dummy data.

Additionally, the procedures of the emulation protocol selection process described in this embodiment are realized by a computer program. Thus, the same effects can be easily realized by implementing the computer program to a computer via a computer-readable recording medium.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus performing wireless communication with an external device, the communication apparatus comprising:
a detection unit configured to detect one or more emulation protocols supported by the external device;
a selection unit configured to select, from the one or more emulation protocols detected by the detection unit, an emulation protocol which is supported by the communication apparatus; and
a connection unit configured to establish a wireless connection with the external device in accordance with the emulation protocol selected by the selection unit.

2. The communication apparatus according to claim 1, wherein the selection unit comprises:
a first selector configured to select, from the one or more emulation protocols detected by the detection unit, emulation protocols which are supported by the communication apparatus;
a measuring unit configured to measure a time period since data is transmitted to the external device until an acknowledge is received with respect to the transmitted data for each of the selected emulation protocols selected by the first selector; and
a second selector configured to select an emulation protocol for which a shortest time period is measured among time periods measured by the measuring unit.

3. The communication apparatus according to claim 1, wherein the emulation protocol converts a procedure for performing a wire communication into a procedure for performing wireless communication.

4. The communication apparatus according to claim 2, wherein the measuring unit includes an encryption process unit configured to encrypt the data to be transmitted.

5. The communication apparatus according to claim 1, wherein the selection unit comprises:
a calculation unit configured to measure a time period since data is transmitted to the external device until an acknowledge is received with respect to the transmitted data for each of the selected emulation protocols, and to calculate an average value of time periods measured a plurality of number of times; and
a selection unit configured to select an emulation protocol for which a smallest average value is calculated among average values calculated by the calculation unit.

6. A communication control method to be applied to a communication apparatus performing wireless communication with an external device, the communication control method comprising:
detecting one or more emulation protocols supported by the external device;
selecting, from the detected one or more emulation protocols, an emulation protocol which is supported by the communication apparatus; and
establishing a wireless connection with the external device in accordance with the selected emulation protocol.

7. The communication control method according to claim 6, wherein selecting the emulation protocol includes:
selecting, from the detected one or more emulation protocols, emulation protocols which are supported by the communication apparatus;
measuring a time period since data is transmitted to the external device until an acknowledge is received with respect to the transmitted data for each of the selected emulation protocols; and
selecting an emulation protocol for which a shortest time period is measured among measured time periods.

8. The communication control method according to claim 6, wherein the emulation protocol converts a procedure for performing a wire communication into a procedure for performing wireless communication.

9. The communication control method according to claim 6, wherein measuring the time period includes encrypting the data to be transmitted.

10. The communication control method according to claim 6, wherein selecting the emulation protocol includes:
measuring a time period since data is transmitted to the external device until an acknowledge is received with respect to the transmitted data for each of the selected emulation protocols, and calculating an average value of time periods measured a plurality of number of times; and
selecting an emulation protocol for which a smallest average value is calculated among average values calculated by calculating the average value.
